(19) United States
(12) Patent Application Publication
(10) Pub. No.: US 2024/0209986 A1
(43) Pub. Date: Jun. 27, 2024

(54) HIGH PRESSURE TANK

(71) Applicant: HONDA MOTOR CO., LTD., TOKYO (JP)

(72) Inventors: Yusuke TSUCHIYAMA, WAKO-SHI (JP); Koei FUJIKI, WAKO-SHI (JP); Kosuke TATSUSHIMA, WAKO-SHI (JP)

(21) Appl. No.: 18/395,583

(22) Filed: Dec. 24, 2023

(30) Foreign Application Priority Data
Dec. 27, 2022 (JP) 2022-210503

(51) Int. Cl. F17C 1/16

(52) U.S. Cl. CPC F17C 1/16; F17C 2201/0109; F17C 2203/012; F17C 2203/0604; F17C 2203/0624; F17C 2203/066; F17C 2203/0673; F17C 2205/0311; F17C 2221/012; F17C 2270/0168; F17C 2270/0184

(57) ABSTRACT

A high pressure tank includes: a liner made of resin and including a round tubular shaped cylinder portion; a first cap member connected to a first connecting end portion of the cylinder portion; a second cap member connected to a second connecting end portion of the cylinder portion; and a reinforcing layer including first reinforcing fibers hoop-wound along a circumferential direction of the cylinder portion. Reinforcing members are laid over the first cap member and the second cap member. The reinforcing members include second reinforcing fibers hoop-wound around the first cap member and the second cap member a plurality of times.

### CROSS-REFERENCE TO RELATED APPLICATIONS

This application is based upon and claims the benefit of priority from Japanese Patent Application No. 2022-210503 filed on Dec. 27, 2022, the contents of which are incorporated herein by reference.

### BACKGROUND OF THE INVENTION

### Field of the Invention

The present invention relates to a high pressure tank in which an outer surface of a liner formed of a resin material is covered with a reinforcing layer.

### Description of the Related Art

The high pressure tank disclosed in JP 2017-110669 A is provided with a liner including a tubular body portion, and dome-shaped side end portions formed at both ends of the body portion. The high pressure tank is obtained by preparing a liner including a tubular portion in which one sheet-shaped fiber-reinforced resin layer is wound a plurality of times from a direction orthogonal to the axis of the body portion over both sides of the body portion so as to have a predetermined thickness from the surface of the liner. Then, the side end portions are covered with a pair of caps from both sides of the liner so as to fill the steps formed between the surface of the tubular portion and the surfaces of the side end portions of the liner due to the thickness of the tubular portion, and a continuous fiber impregnated with resin is helically wound around the tubular portion and the pair of caps.

### SUMMARY OF THE INVENTION

In the high pressure tank disclosed in JP 2017-110669 A, the fiber-reinforced resin layer for reinforcing the side end portions is helically wound, and hardly contributes to the reinforcement of the body portion, and the continuous fiber is excessively used by the amount used for helically winding the body portion. This leads to an increase in the manufacturing cost of the high pressure tank and an increase in the weight of the high pressure tank. In particular, in the case of a high pressure tank, which is mounted on a vehicle having a long overall length such as a commercial vehicle and which has a body portion that is long in the longitudinal direction, it is assumed that the amount of the continuous fiber used for helical winding increases, which leads to a further increase in the manufacturing cost and weight.

According to an aspect of the present invention, there is provided a high pressure gas tank comprising: a liner which is made of resin, and includes a cylinder portion having a round tubular shape, and a gas filling chamber formed in an interior of the liner; a first cap member attached to one end part in an axial direction of the liner; a second cap member attached to another end part in the axial direction of the liner; a reinforcing layer configured to cover an outer surface of the cylinder portion and including first reinforcing fibers hoop-wound a plurality of times along a circumferential direction of the cylinder portion; and a reinforcing member that is laid over the first cap member and the second cap member, and includes second reinforcing fibers hoop-wound around the first cap member and the second cap member a plurality of times, the second reinforcing fibers extending in an axial direction of the cylinder portion between the first cap member and the second cap member.

According to the present invention, the reinforcing member is laid over the first cap member attached to one end part in the axial direction of the liner and the second cap member attached to the other end part in the axial direction of the liner. The reinforcing member includes the second reinforcing fibers hoop-wound around the first cap member and the second cap member a plurality of times. Therefore, since the reinforcing fibers are not helically wound in any of the reinforcing layer and the reinforcing member, the amount of the reinforcing fibers used can be reduced as compared with a high pressure tank obtained by using helical winding, and accordingly, the manufacturing cost and the weight of the high pressure tank can be reduced. Suppressing the amount of the fibers used is also environmentally friendly.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an external perspective view of a high pressure tank according to a first embodiment of the present invention;

FIG. 2 is an overall cross-sectional view of the high pressure tank shown in FIG. 1;

FIG. 3 is a front view of the high pressure tank shown in FIG. 1;

FIG. 4 is an enlarged perspective view of the vicinity of a first cap member of a high pressure tank according to a first modification;

FIG. 5 is an enlarged cross-sectional view of the vicinity of a first cap member of a high pressure tank according to a second modification;

FIG. 6 is an overall cross-sectional view of a high pressure tank according to a second embodiment of the present invention;

FIG. 7 is an enlarged cross-sectional view of the vicinity of a first cap member of a high pressure tank according to a third modification; and

FIG. 8 is an overall cross-sectional view of a high pressure tank according to a third embodiment of the present invention.

### DETAILED DESCRIPTION OF THE INVENTION

A high pressure tank 10 according to the present embodiment is used with the aim of storing hydrogen gas. The high pressure tank 10 is mounted on a fuel cell vehicle. The high pressure tank 10 stores the hydrogen gas which is supplied to a fuel cell system.

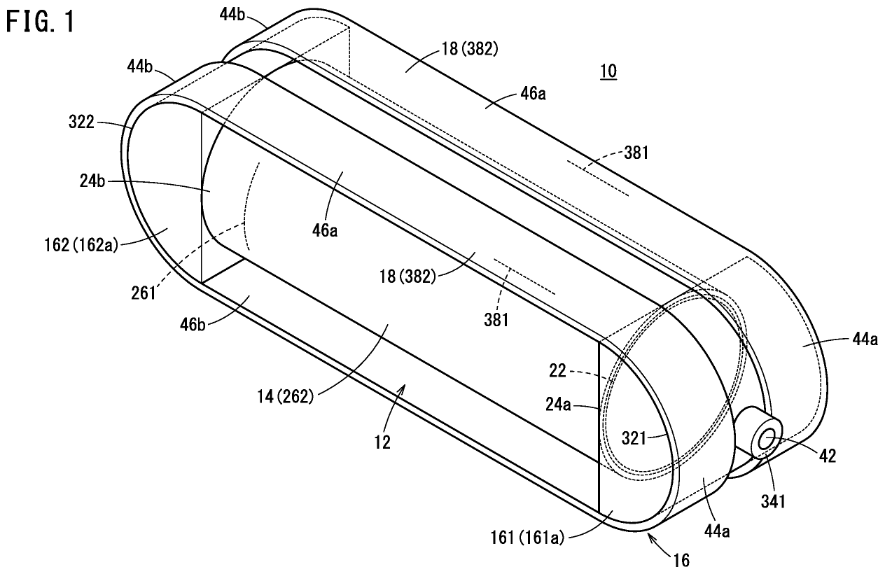

The high pressure tank 10 according to a first embodiment shown in FIG. 1 includes a liner 12, a reinforcing layer 14, a pair of cap members 16, and a pair of reinforcing members 18.

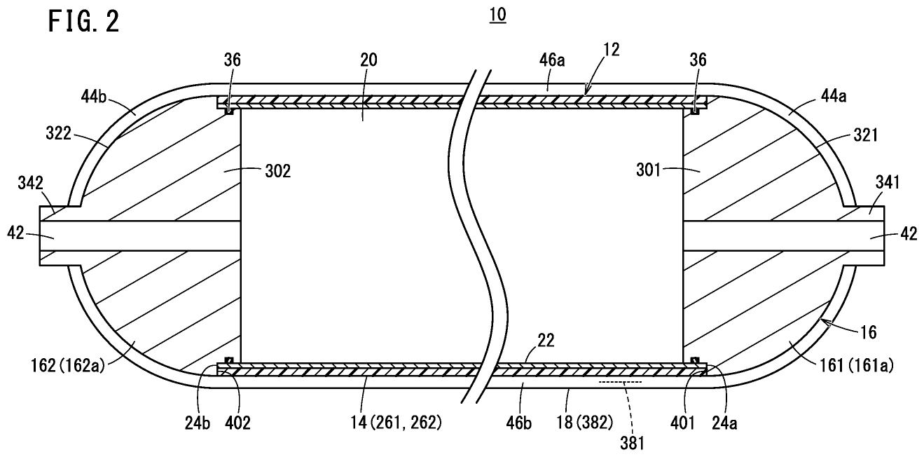

The liner 12 serves as an inner layer of the high pressure tank 10. The liner 12 is a hollow body formed of a resin material. The interior of the liner 12 includes a gas filling chamber 20 capable of containing high-pressure gas such as hydrogen gas (see FIG. 2). The liner 12 includes a cylinder portion 22, and a pair of first and second connecting end portions 24a and 24b. Hereinafter, a case where hydrogen gas is filled into the high pressure tank 10 will be described.

The cylinder portion 22 is formed in a round tubular shape and with a constant diameter along the axial direction. The interior of the cylinder portion 22 serves as the gas filling chamber 20 that is filled with hydrogen gas.

As shown in FIG. 2, one end part in the axial direction of the cylinder portion 22 is provided with the first connecting end portion 24a. The first connecting end portion 24a opens in the axial direction of the cylinder portion 22. Another end part in the axial direction of the cylinder portion 22 is provided with the second connecting end portion 24b. The second connecting end portion 24b opens in the axial direction of the cylinder portion 22.

The reinforcing layer 14 is disposed on the outer circumferential surface of the cylinder portion 22, and covers the outer circumferential surface. The reinforcing layer 14 covers the outer circumferential surface of the cylinder portion 22 over the entire length of the cylinder portion 22. Specifically, the reinforcing layer 14 covers the cylinder portion 22 from the first connecting end portion 24a to the second connecting end portion 24b.

Although the reinforcing layer 14 is schematically shown in FIGS. 1 and 2, the reinforcing layer 14 includes first reinforcing fibers 261 and a resin base material 262 impregnated in each first reinforcing fiber 261. The reinforcing layer 14 is formed of, for example, a carbon fiber reinforced resin (CFRP). In a manufacturing process of the high pressure tank 10, the first reinforcing fibers 261 that is impregnated with the resin are wound around the outer circumferential surface of the liner 12 a plurality of times by a sheet winding method using a non-illustrated filament winding device or pultrusion device. The reinforcing layer 14 is a laminated body obtained by winding the first reinforcing fibers 261 around the liner 12, and thereafter, performing heating to cause the resin base material 262 to harden.

Specifically, the reinforcing layer 14 is a hoop layer in which the first reinforcing fibers 261 are hoop-wound around the outer circumferential surface of the cylinder portion 22 along the circumferential direction thereof. The hoop winding is a winding method in which the first reinforcing fibers 261 are wound in a manner so that the first reinforcing fibers 261 extend in a direction substantially orthogonal to the axial direction of the cylinder portion 22 of the liner 12.

The pair of cap members 16 (hereinafter referred to as first and second cap members 161 and 162) are formed of a metal material. The first cap member 161 is a first boss member 161a connected to the first connecting end portion 24a of the cylinder portion 22. The second cap member 162 is a second boss member 162a connected to the second connecting end portion 24b of the cylinder portion 22. The first and second cap members 161 and 162 are formed in a rectangular shape when viewed from the axial direction of the first and second cap members 161 and 162. The first cap member 161 and the second cap member 162 have substantially the same shape. The first cap member 161 includes a connecting portion 301, a curved outer surface 321, and a ferrule member 341. The second cap member 162 includes a connecting portion 302, a curved outer surface 322, and a ferrule member 342.

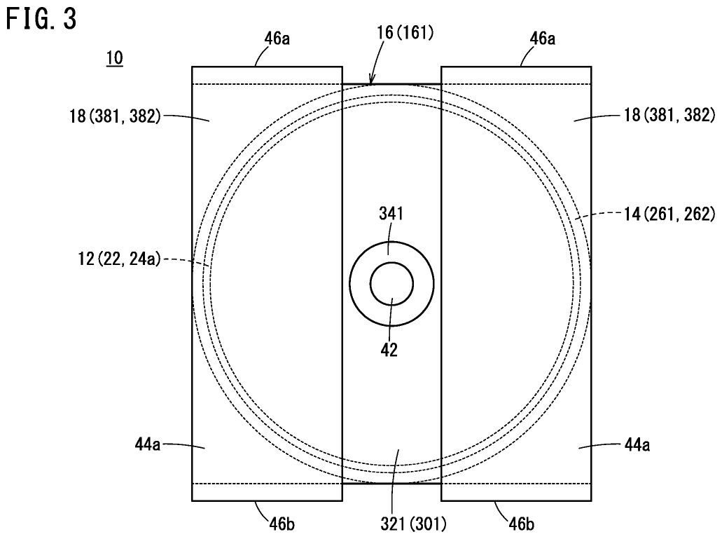

The connecting portions 301 and 302 are connected to the first and second connecting end portions 24a and 24b of the cylinder portion 22, respectively. The connecting portions 301 and 302 are formed in a circular shape when viewed from the axial direction of the cylinder portion 22 shown in FIG. 3. The connecting portions 301 and 302 are formed to have outer diameters such that the connecting portions 301 and 302 can be respectively inserted into the first and second connecting end portions 24a and 24b. As shown in FIG. 2, the connecting portions 301 and 302 have a predetermined length in the axial direction, and seal rings 36 are attached to the outer circumferential surfaces of the connecting portions 301 and 302 via annular grooves. The connecting portions 301 and 302 are inserted into the first and second connecting end portions 24a and 24b, respectively. At this time, the seal rings 36 abut against the inner circumferential surfaces of the first and second connecting end portions 24a and 24b. Thus, the airtightness between the connecting portions 301 and 302 of the first and second cap members 161 and 162, and the gas filling chamber 20 of the cylinder portion 22 is maintained.

Second reinforcing fibers 381 constituting the reinforcing members 18 are wound around the curved outer surfaces 321 and 322. As shown in FIG. 3, when viewed from the axial direction of the high pressure tank 10, the curved outer surfaces 321 and 322 are formed in a rectangular shape, and cover the first and second connecting end portions 24a and 24b of the cylinder portion 22. As shown in FIG. 2, when viewed from a direction orthogonal to the axial direction of the liner 12, the curved outer surfaces 321 and 322 are formed in a semicircular shape in cross section. The curved outer surfaces 321 and 322 each have an arc-shaped cross section that bulges convexly in a direction away from each of the connecting portions 301 and 302. The curved outer surfaces 321 and 322 are curved surfaces having a predetermined radius and a center on the axial line of the first and second cap members 161 and 162. The shape of the curved outer surfaces 321 and 322 is not limited to a true arc, and may be a shape close to an arc. For example, the curved outer surfaces 321 and 322 may have a curved shape formed by connecting a plurality of arcs having different radii of curvature.

The first and second cap members 161 and 162 have abutment surfaces 401 and 402 disposed on the opposite sides from the curved outer surfaces 321 and 322. The abutment surfaces 401 and 402 are annular surfaces adjacent to the connecting portions 301 and 302 and extending about the axial line of the liner 12. When the connecting portion 301 of the first cap member 161 is inserted into the first connecting end portion 24a, the abutment surface 401 abuts against the first connecting end portion 24a of the cylinder portion 22. When the connecting portion 302 of the second cap member 162 is inserted into the second connecting end portion 24b, the abutment surface 402 abuts against the second connecting end portion 24b of the cylinder portion 22. As a result, the first and second cap members 161 and 162, and the cylinder portion 22 are positioned in the axial direction.

The ferrule members 341 and 342 are provided on the axial line of the liner 12. The ferrule members 341 and 342 protrude in the axial direction from the tops of the curved outer surfaces 321 and 322. The directions in which the ferrule members 341 and 342 protrude are directions away from the connecting portions 301 and 302. Gas flow passages 42 are provided inside the ferrule members 341 and 342, respectively. The gas flow passages 42 open at distal ends of the ferrule members 341 and 342, and penetrates from the ferrule members 341 and 342 to end parts of the connecting portions 301 and 302. When the connecting portions 301 and 302 of the first and second cap members 161 and 162 are connected to the cylinder portion 22, the gas flow passages 42 communicate with the gas filling chamber 20. Non-illustrated pipes are respectively connected to the distal ends of the ferrule members 341 and 342. As a result, when the gas filling chamber 20 of the high pressure tank 10 is filled with hydrogen gas, the hydrogen gas can be discharged to the outside through the gas flow passages 42, and the hydrogen gas can be filled into the gas filling chamber 20 from the outside through the gas flow passages 42.

When the connecting portion 301 of the first cap member 161 is connected to the first connecting end portion 24a of the cylinder portion 22, and the connecting portion 302 of the second cap member 162 is connected to the second connecting end portion 24b of the cylinder portion 22, the curved outer surfaces 321 and 322 bulge in directions away from each other along the axial direction of the cylinder portion 22.

The reinforcing members 18 each include the second reinforcing fibers 381 hoop-wound around the first cap member 161 and the second cap member 162 a plurality of times, and a resin base material 382 impregnated in each second reinforcing fiber 381. In FIG. 2, the second reinforcing fibers 381 are partially and schematically shown. The reinforcing member 18 is formed of a fiber reinforced resin. The reinforcing member 18 is formed of, for example, a carbon fiber reinforced resin (CFRP). The reinforcing member 18 is formed in an oval band shape. The reinforcing member 18 includes a predetermined width in a direction orthogonal to the extending direction thereof. The width of the reinforcing member 18 is constant in the extending direction.

The reinforcing member 18 includes a pair of curved portions 44a and 44b, and a pair of linking portions 46a and 46b that link one curved portion 44a and the other curved portion 44b. The pair of curved portions 44a and 44b are disposed at both ends in the longitudinal direction of the reinforcing member 18. The pair of curved portions 44a and 44b can be brought into close contact with the curved outer surfaces 321 and 322 of the first and second cap members 161 and 162, respectively. The pair of linking portions 46a and 46b extend in the longitudinal direction of the reinforcing member 18. The pair of linking portions 46a and 46b are parallel to each other and spaced apart from each other by a predetermined distance in a direction orthogonal to the longitudinal direction of the reinforcing member 18.

When the first cap member 161 is connected to the first connecting end portion 24a of the cylinder portion 22 and the second cap member 162 is connected to the second connecting end portion 24b of the cylinder portion 22, one of the reinforcing members 18 is disposed on one side in the width direction of the ferrule member 341 of the first cap member 161 and the ferrule member 342 of the second cap member 162. The other reinforcing member 18 is disposed on the other side in the width direction of the ferrule member 341 of the first cap member 161 and the ferrule member 342 of the second cap member 162. Specifically, the pair of reinforcing members 18 are disposed in parallel to each other and spaced apart from each other in the width direction with the ferrule members 341 and 342 interposed therebetween.

The curved portion 44a is attached to the curved outer surface 321 of the first cap member 161. The inner surface of the curved portion 44a comes into close contact with the curved outer surface 321. The curved portion 44b is attached to the curved outer surface 322 of the second cap member 162. The inner surface of the curved portion 44b comes into close contact with the curved outer surface 322. The radius of the inner surface of each of the curved portions 44a and 44b corresponds to the radius of each of the curved outer surfaces 321 and 322.

The pair of linking portions 46a and 46b are disposed between an end part of the curved outer surface 321 of the first cap member 161 and an end part of the curved outer surface 322 of the second cap member 162. The pair of linking portions 46a and 46b are disposed radially outward of the outer circumferential surface of the cylinder portion 22. The pair of linking portions 46a and 46b are disposed in parallel with the cylinder portion 22.

When the reinforcing members 18 are attached to the first cap member 161 and the second cap member 162, the first and second cap members 161 and 162 are biased by the reinforcing members 18 in directions in which the first and second cap members 161 and 162 approach each other. The first cap member 161 and the second cap member 162 are respectively pushed toward the cylinder portion 22 side by the pair of reinforcing members 18.

In a case where the high pressure tank 10 is assembled, first, the reinforcing layer 14 is formed on the outer circumferential surface of the cylinder portion 22 by hoop winding, and then the connecting portions 301 and 302 of the first and second cap members 161 and 162 are connected to the first and second connecting end portions 24a and 24b of the cylinder portion 22 to form a temporary assembly. Next, a compressive load is applied by a non-illustrated load applying device to the first and second cap members 161 and 162 toward the cylinder portion 22 side in the directions in which the first and second cap members 161 and 162 approach each other. As a result, the cylinder portion 22 is slightly contracted in the axial direction within an elastic deformation region between the first cap member 161 and the second cap member 162. Thus, the axial dimension of the temporary assembly including the first and second cap members 161 and 162 and the cylinder portion 22 is slightly reduced.

The pair of reinforcing members 18 are attached to the first and second cap members 161 and 162 of the temporary assembly compressed in the axial direction. The length of the reinforcing members 18 in the longitudinal direction is the distance from an apex of the curved portion 44a to an apex of the curved portion 44b. The longitudinal dimension of the reinforcing members 18 is shorter than the axial dimension of the temporary assembly, and is longer than the axial dimension at the time of compression of the temporary assembly compressed in the axial direction due to the application of the compressive load.

In a state where the compressive load is applied to the temporary assembly in the axial direction, the curved portions 44a and 44b of the reinforcing members 18 are disposed outside the curved outer surface 321 of the first cap member 161 and outside the curved outer surface 322 of the second cap member 162, respectively.

By reducing the compressive load in the axial direction applied to the temporary assembly by the non-illustrated load applying device, the cylinder portion 22 is expanded in the axial direction by the elastic restoring force thereof, and the first cap member 161 and the second cap member 162 are biased in directions away from each other and relatively moved. As a result, the curved portions 44a and 44b of the pair of reinforcing members 18 are pulled in directions away from each other (in the longitudinal direction) along the axial direction of the cylinder portion 22 by the curved outer surface 321 of the first cap member 161 and the curved outer surface 322 of the second cap member 162.

At this time, since the longitudinal dimension of the reinforcing members 18 is shorter than the axial dimension of the temporary assembly, a predetermined tension is applied to the pair of reinforcing members 18 in the longitudinal direction, and the first and second cap members 161 and 162 are pushed toward the cylinder portion 22 by this tension. Thus, the first and second cap members 161 and 162 are firmly fixed to the first and second connecting end portions 24a and 24b of the cylinder portion 22, and the assembly of the high pressure tank 10 is completed.

Next, a case where the high pressure tank 10 is filled with hydrogen gas will be described.

First, in a case where hydrogen gas is stored in the high pressure tank 10, the hydrogen gas is supplied to the gas flow passage (s) 42 of both or either one of the ferrule members 341 and 342 through the non-illustrated pipe (s). The hydrogen gas is introduced from the gas flow passage 42 into the gas filling chamber 20 of the liner 12 and is filled into the gas filling chamber 20. At this time, the internal pressure of the liner 12 is increased by the hydrogen gas introduced into the gas filling chamber 20. As the internal pressure of the liner 12 increases, the cylinder portion 22 of the liner 12 is slightly expanded radially outward, and the first and second cap members 161 and 162 are pushed in directions away from the cylinder portion 22 (in the axial direction). Since the first and second cap members 161 and 162 are pressed against the cylinder portion 22 by the tension of the pair of reinforcing members 18, the first and second cap members 161 and 162 are prevented from being separated from the cylinder portion 22 by the internal pressure of the liner 12.

Next, in a case where the hydrogen gas stored in the high pressure tank 10 is discharged to the outside, the gas flow passages 42 of the ferrule members 341 and 342 are opened by a non-illustrated switching device, and the hydrogen gas in the tank is discharged to the pipes through the gas flow passages 42. At this time, the internal pressure of the liner 12 is reduced in accordance with the discharge of the hydrogen gas, and the cylinder portion 22 of the liner 12 is slightly contracted radially inward.

It should be noted that present invention is not limited to the configuration in which the first and second cap members 161 and 162 are provided with the ferrule members 341 and 342, respectively, and at least one of the first and second cap members 161 and 162 may be provided with the ferrule member 341 or 342, and the other of the first and second cap members 161 and 162 may have a shape that closes the end part of the cylinder portion 22 without including the ferrule member 341 or 342.

As described above, in the high pressure tank 10 according to the first embodiment, the reinforcing layer 14 including the first reinforcing fibers 261 hoop-wound around the cylinder portion 22 covers the cylinder portion 22. The reinforcing members 18 including the second reinforcing fibers 381 hoop-wound around the first and second cap members 161 and 162 are laid over the first and second cap members 161 and 162. Therefore, the first and second reinforcing fibers 261 and 381 are not helically wound in either of the reinforcing layer 14 and the reinforcing members 18. As a result, the amount of the first and second reinforcing fibers 261 and 381 used can be reduced as compared with a high pressure tank obtained by using helical winding. Therefore, the manufacturing cost and the weight of the high pressure tank 10 can be reduced. Suppressing the amount of the reinforcing fibers used is also environmentally friendly.

By respectively providing the first and second cap members 161 and 162 with the curved outer surfaces 321 and 322 each bulging convexly in a direction away from the central portion in the axial direction of the cylinder portion 22, the reinforcing members 18 laid over the curved outer surfaces 321 and 322 is prevented from being applied with a local load, and a tightening force in the axial direction can be favorably applied to the liner 12 by the reinforcing members 18 via the first cap member 161 and the second cap member 162.

Since the liner 12 includes the cylinder portion 22 having a round tubular shape as a whole, the liner 12 can be formed in a simple configuration. In addition, since the first and second cap members 161 and 162 function as the first and second boss members 161a and 162a, respectively, the high pressure tank 10 can be formed in a relatively simple configuration as a whole while including the pair of reinforcing members 18.

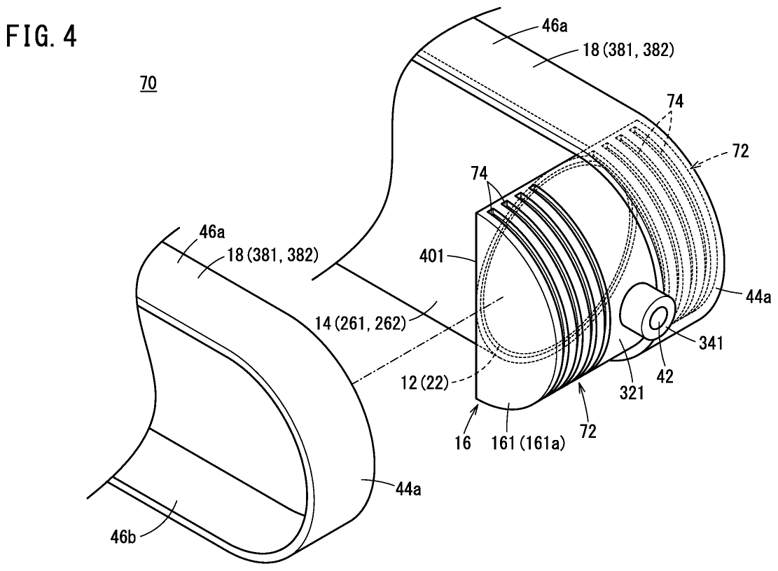

A high pressure tank 70 according to a first modification shown in FIG. 4 includes groove portions 72 in the curved outer surfaces 321 and 322 of the first and second cap members 161 and 162. The groove portions 72 are disposed on the curved outer surfaces 321 and 322. The groove portions 72 each include a plurality of engagement grooves 74 recessed with respect to the surfaces of the curved outer surfaces 321 and 322. Hereinafter, a case where the first cap member 161 shown in FIG. 4 is provided with the groove portion 72 and the groove portion 72 is provided with four engagement grooves 74 will be described, but the number of the engagement grooves 74 is not limited to four and may be one to three or more than four.

The plurality of engagement grooves 74 have a curved shape extending in the curve direction of the curved outer surface 321. The plurality of engagement grooves 74 are arranged at equal intervals in the width direction of the first cap member 161. When the curved portion 44a of the reinforcing member 18 abuts against the curved outer surface 321, the plurality of engagement grooves 74 and the inner surface of the curved portion 44a face each other and come into contact with each other. When the tension acts on the reinforcing member 18, the curved portion 44a is pressed against the curved outer surface 321 by the tension, and a portion of the inner surface of the curved portion 44a is inserted into and engaged with the engagement grooves 74.

In the high pressure tank 70 according to the first modification, when the reinforcing members 18 are wound around the curved outer surfaces 321 and 322 of the first and second cap members 161 and 162, the curved portions 44a and 44b of the reinforcing members 18 are engaged with the plurality of engagement grooves 74 on the curved outer surfaces 321 and 322. This effectively prevents the reinforcing members 18 from being displaced in the width direction with respect to the first and second cap members 161 and 162, and also prevents the reinforcing members 18 from falling off from the first and second cap members 161 and 162.

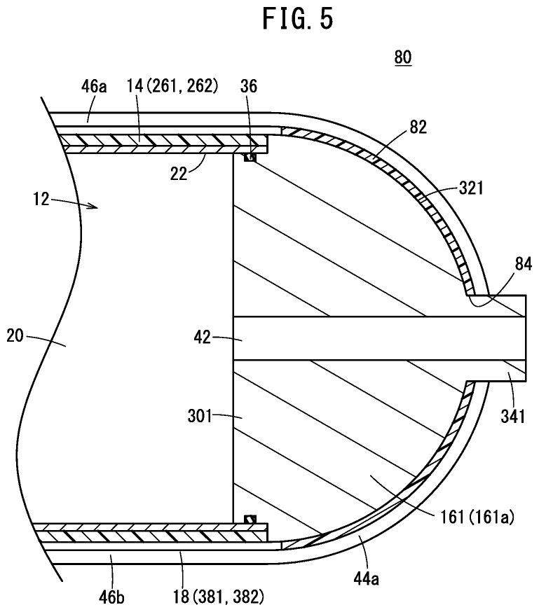

A high pressure tank 80 according to a second modification shown in FIG. 5 includes a cushion member 82 having an elastic force. The cushion member 82 is formed of an elastic material such as a foamed resin. Hereinafter, a case where the cushion member 82 is disposed between the first cap member 161 and the curved portion 44a of the reinforcing member 18 will be described with reference to FIG. 5. When viewed from the axial direction of the cylinder portion 22, the cushion member 82 has a quadrangular shape. When viewed from a direction orthogonal to the axial line of the cylinder portion 22, the cross section of the cushion member 82 has a curved shape (a semicircular shape in the mode shown in FIG. 5) following the curve of the curved outer surface 321. The cushion member 82 covers the curved outer surface 321 of the first cap member 161. The cushion member 82 includes, at the center thereof, a first hole portion 84 through which the ferrule member 341 can be inserted.

For example, when the cushion member 82 is pressed in the axial direction by a non-illustrated load applying device under the condition that the internal pressure of the gas filling chamber 20 in the liner 12 is 0 MPa and the ambient temperature of the high pressure tank 80 is 23 ºC, an amount of compressive deformation (an amount of crushing) of the cushion member 82 in the thickness direction thereof falls within the range of 0.2% to 0.7% of the axial dimension of the liner 12.

The tension of the reinforcing member 18 is applied to the curved outer surface 321 of the first cap member 161 from the curved portion 44a through the cushion member 82. The present invention is not limited to the case where the cushion member 82 is disposed on each of the first cap member 161 and the second cap member 162, and the cushion member 82 may be provided on at least one of the first and second cap members 161 and 162.

In the high pressure tank 80 according to the second modification, the cushion member 82 is disposed between the reinforcing member 18 and each of the first and second cap members 161 and 162, and thus the curved portions 44a and 44b of the reinforcing member 18 can be constantly biased radially outward by the elastic force of the cushion member 82. Therefore, the tension of the reinforcing member 18 can be effectively maintained by the elastic force of the cushion member 82. In particular, when the high pressure tank 80 is used in a low-temperature environment and the liner 12 made of a resin material contracts in the axial direction and the radial direction, the reinforcing member 18 is pushed outward by the cushion member 82, whereby the reinforcing member 18 can be reliably held by the cushion member 82, and the state in which the first and second cap members 161 and 162 are fixed by the reinforcing member 18 can be maintained.

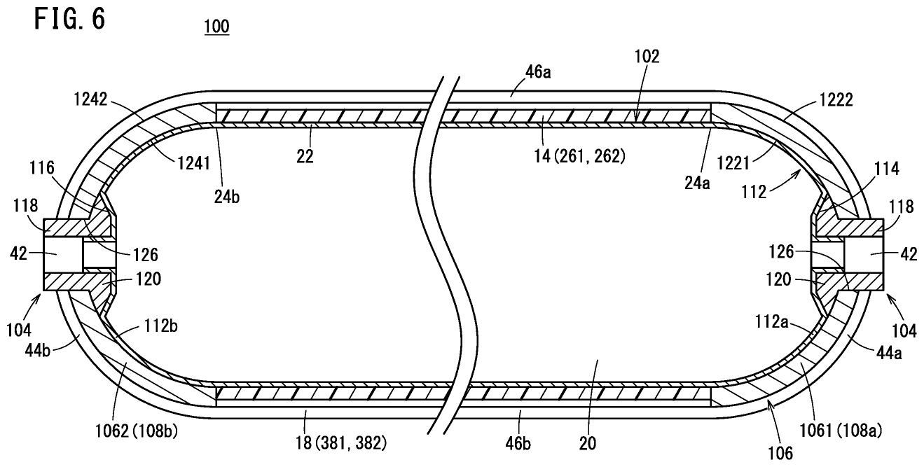

A high pressure tank 100 according to a second embodiment shown in FIG. 6 includes a liner 102, the reinforcing layer 14, ferrules 104, a pair of cap members 106, and the pair of reinforcing members 18. It should be noted that the same constituent elements as those of the high pressure tank 10 according to the first embodiment are denoted by the same reference numerals, and detailed description thereof will be omitted.

The liner 102 is a hollow body formed of a resin material. The liner 102 includes the cylinder portion 22, and a pair of dome portions 112 (hereinafter referred to as first and second dome portions 112a and 112b) which are disposed at end parts in the axial direction of the cylinder portion 22.

The first dome portion 112a is disposed at one end in the axial direction of the cylinder portion 22. The first dome portion 112a is of a curved shape that gradually curves radially inward in a direction away from the cylinder portion 22. When viewed from a direction orthogonal to an axial direction of the liner 102, the cross-sectional shape of the first dome portion 112a is a semicircular shape. The first dome portion 112a includes, at the center thereof, a first recessed part 114 that is recessed in the axial direction with respect to the first dome portion 112a.

The second dome portion 112b is disposed at another end in the axial direction of the cylinder portion 22. The second dome portion 112b is of a curved shape that gradually curves radially inward in a direction away from the cylinder portion 22. When viewed from a direction orthogonal to the axial direction of the liner 102, the cross-sectional shape of the second dome portion 112b is a semicircular shape. In the axial direction of the liner 102, the first dome portion 112a and the second dome portion 112b are curved radially inward in a manner so as to reduce in diameter in directions away from each other. The second dome portion 112b includes, at the center thereof, a second recessed part 116 that is recessed in the axial direction with respect to the second dome portion 112b.

The reinforcing layer 14 is disposed on the cylinder portion 22 of the liner 102. The reinforcing layer 14 covers the outer circumferential surface of the cylinder portion 22. The reinforcing layer 14 covers the cylinder portion 22 from the first connecting end portion 24a to the second connecting end portion 24b. The reinforcing layer 14 includes the first reinforcing fibers 261, and the resin base material 262 impregnated in each first reinforcing fiber 261. The reinforcing layer 14 is a hoop layer in which the first reinforcing fibers 261 are hoop-wound around the outer circumferential surface of the cylinder portion 22 along the circumferential direction thereof.

The ferrules 104 are formed of a metal material. The ferrules 104 are disposed on the first and second dome portions 112a and 112b, respectively. The ferrules 104 each include a ferrule main body 118 and a flange member 120. The ferrule main body 118 is of a round tubular shape in which the gas flow passage 42 is included. The gas flow passage 42 penetrates in the axial direction through the center of the ferrule main body 118. A non-illustrated pipe can be connected to a distal end of the ferrule main body 118.

The flange member 120 is disposed at a proximal end of the ferrule main body 118. The flange member 120 expands radially outward from an outer circumferential surface of the ferrule main body 118. The flange members 120 are accommodated and fixed in the first and second recessed parts 114 and 116, respectively. When the ferrules 104 are fixed to the first and second recessed parts 114 and 116, the ferrules 104 are disposed on the axial line of the liner 102, and the gas flow passages 42 of the ferrules 104 communicate with the gas filling chamber 20 of the liner 102.

The pair of cap members 106 (hereinafter, referred to as first and second cap members 1061 and 1062) are formed of a metal material. The first cap member 1061 is attached to the first dome portion 112a of the liner 102. The second cap member 1062 is attached to the second dome portion 112b of the liner 102. The first and second cap members 1061 and 1062 have a quadrangular shape when viewed from the axial direction of the liner 102. The cross-sectional shape of the first and second cap members 1061 and 1062 is a semicircular shape when viewed from a direction orthogonal to the axial direction of the liner 102. The thickness of the first and second cap members 1061 and 1062 in the radial direction is substantially constant.

The first cap member 1061 includes a first cap main body 108a. The first cap main body 108a includes a first concave part 1221 and a first curved outer surface 1222.

The first concave part 1221 is formed on the inner side of the first cap member 1061. The first concave part 1221 has a circular shape when viewed from the axial direction of the liner 102. The first concave part 1221 includes a hemispherical surface lying along an outer circumferential surface of the first dome portion 112a. The first concave part 1221 abuts against the outer circumferential surface of the first dome portion 112a. The first dome portion 112a is inserted into the first concave part 1221. The outer circumferential surface of the first dome portion 112a is covered with the first cap member 1061.

The first curved outer surface 1222 is disposed on the outer side of the first cap member 1061. The first curved outer surface 1222 is disposed radially outward of the first concave part 1221. The configuration of the first curved outer surface 1222 is the same as that of the curved outer surface 321 of the first cap member 161 of the high pressure tank 10 according to the first embodiment.

The second cap member 1062 includes a second cap main body 108b. The second cap main body 108b includes a second concave part 1241 and a second curved outer surface 1242. The second concave part 1241 is formed on the inner side of the second cap member 1062. The second concave part 1241 has a circular shape when viewed from the axial direction of the liner 102. The second concave part 1241 includes a hemispherical surface lying along an outer circumferential surface of the second dome portion 112b. The second concave part 1241 abuts against the outer circumferential surface of the second dome portion 112b. The second dome portion 112b is inserted into the second concave part 1241. The outer circumferential surface of the second dome portion 112b is covered with the second cap member 1062.

The second curved outer surface 1242 is disposed on the outer side of the second cap member 1062. The second curved outer surface 1242 is disposed radially outward of the second concave part 1241. The configuration of the second curved outer surface 1242 is the same as that of the curved outer surface 322 of the second cap member 162 of the high pressure tank 10 according to the first embodiment. The pair of reinforcing members 18 are attached to the first curved outer surface 1222 of the first cap member 1061 and the second curved outer surface 1242 of the second cap member 1062.

A second hole portion 126 is formed at the center of each of the first and second cap members 1061 and 1062 so as to penetrate therethrough in the axial direction. The ferrule main body 118 of the ferrule 104 is inserted into the second hole portion 126. The first cap member 1061 covers the outer circumferential surface of the first dome portion 112a and is disposed radially outward of the ferrule main body 118. The second cap member 1062 covers the outer circumferential surface of the second dome portion 112b and is disposed radially outward of the ferrule main body 118. It should be noted that the present invention is not limited to the configuration in which the first and second dome portions 112a and 112b are each provided with the ferrule 104, and at least one of the first and second dome portions 112a and 112b may be provided with the ferrule 104.

As described above, in the second embodiment, it is possible to attach the first and second cap members 1061 and 1062 to the high pressure tank 100 (the liner 102) having a general structure in which the first and second dome portions 112a and 112b are provided, and it becomes possible to secure the strength of the liner 102 by holding the first and second cap members 1061 and 1062 with the pair of reinforcing members 18 without performing helical winding. As a result, the amount of the reinforcing fibers used can be reduced as compared with a high pressure tank obtained by using helical winding, and the manufacturing cost and the weight of the high pressure tank 100 can be reduced.

By respectively providing the first and second cap members 1061 and 1062 with the first and second curved outer surfaces 1222 and 1242 each bulging convexly in a direction away from the central portion in the axial direction of the cylinder portion 22, the pair of reinforcing members 18 laid over the first curved outer surface 1222 and the second curved outer surface 1242 are not subjected to a local load, and a tightening force in the axial direction can be favorably applied to the liner 102 by the reinforcing members 18 via the first cap member 1061 and the second cap member 1062.

By attaching the pair of reinforcing members 18 to the arc-shaped first and second curved outer surfaces 1222 and 1242, the first and second cap members 1061 and 1062 can be stably pushed in the directions in which they approach each other.

It should be noted that, in the high pressure tank 100 of the second embodiment, the first curved outer surface 1222 of the first cap member 1061 and the second curved outer surface 1242 of the second cap member 1062 may each include the groove portion 72 as shown in FIG. 4. As a result, when the reinforcing members 18 are attached to the first and second curved outer surfaces 1222 and 1242 of the first and second cap members 1061 and 1062, the reinforcing members 18 including the second reinforcing fibers 381 are engaged with the engagement grooves 74 of the groove portions 72, whereby the reinforcing members 18 are suitably prevented from being displaced in a direction orthogonal to the winding direction of the second reinforcing fibers 381.

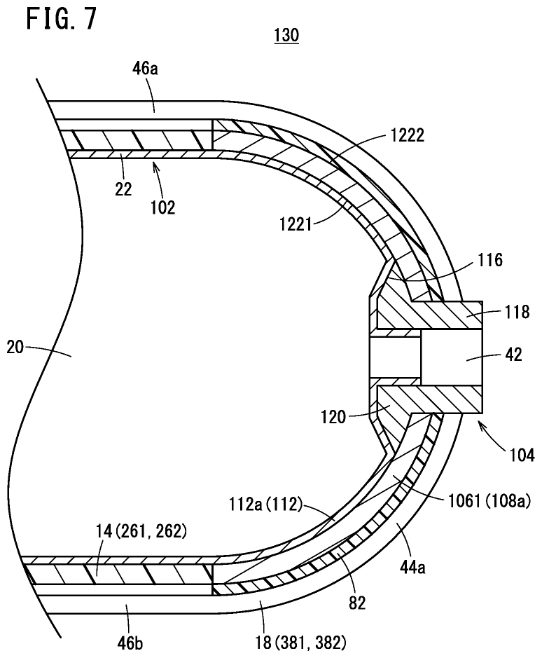

A high pressure tank 130 according to a third modification shown in FIG. 7 includes the cushion member 82 having an elastic force on the outer circumferences of the pair of first and second cap members 1061 and 1062. It should be noted that the configuration of the cushion member 82 is the same as the cushion member 82 used in the high pressure tank 80 according to the second modification shown in FIG. 5. Therefore, in the present description, the cushion member 82 is denoted by the same reference numeral, and detailed description thereof will be omitted. Specifically, the high pressure tank 130 of the third modification has a structure in which the outside of each of the first and second dome portions 112a and 112b is covered with two layers, namely, each of the first and second cap members 1061 and 1062, and the cushion member 82. The present invention is not limited to the case where the cushion member 82 is disposed on each of the first cap member 1061 and the second cap member 1062, and the cushion member 82 may be provided on at least one of the first and second cap members 1061 and 1062.

In the high pressure tank 130 according to the third modification, the cushion member 82 is disposed between the reinforcing member 18 and each of the first and second cap members 1061 and 1062, and thus the curved portions 44a and 44b of the reinforcing member 18 can be constantly biased radially outward by the elastic force of the cushion member 82, and therefore, the tension of the reinforcing member 18 can be effectively maintained by the elastic force of the cushion member 82. In particular, when the high pressure tank 130 is used in a low-temperature environment and the liner 102 made of a resin material contracts in the axial direction and the radial direction, the reinforcing member 18 is pushed outward by the cushion member 82, whereby the reinforcing member 18 can be reliably held by the cushion member 82, and the state in which the first and second cap members 1061 and 1062 are fixed by the reinforcing member 18 can be maintained.

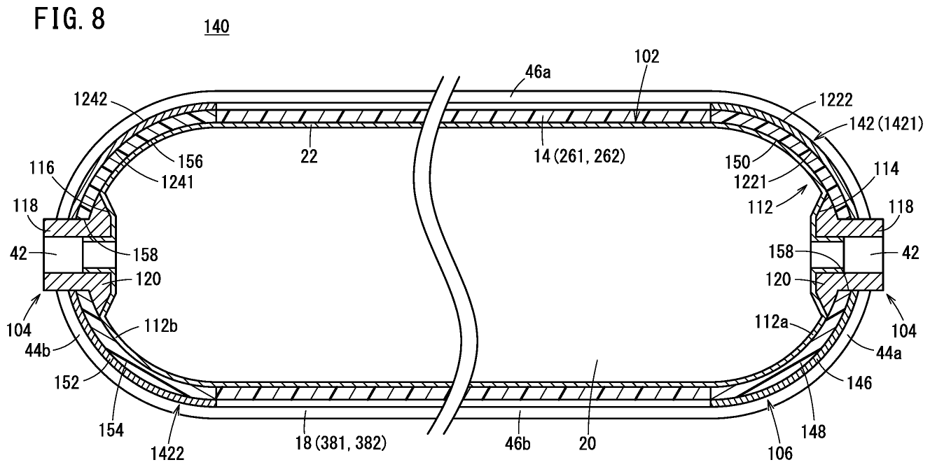

A high pressure tank 140 according to a third embodiment shown in FIG. 8 includes the liner 102, the reinforcing layer 14, a pair of cap members 142, and the pair of reinforcing members 18. It should be noted that the same constituent elements as those of the high pressure tank 100 according to the second embodiment are denoted by the same reference numerals, and detailed description thereof will be omitted.

The pair of cap members 142 is constituted by a first cap member 1421 and a second cap member 1422. The first cap member 1421 includes a first cap main body 146 and a first reinforcing cap 148. The first cap main body 146 is formed of a metal material. The first cap main body 146 has a quadrangular shape when viewed from the axial direction of the liner 102. When viewed from a direction orthogonal to the axial direction of the liner 102, the first curved outer surface 1222 of the first cap main body 146 is formed in a semicircular shape in cross section. The first cap main body 146 includes a first fitting concave part 150 on the inner side thereof. The first reinforcing cap 148 is fitted into the first fitting concave part 150. The first fitting concave part 150 has a hemispherical surface.

The first reinforcing cap 148 is formed in a cup shape from a fiber reinforced resin (FRP). The first reinforcing cap 148 has a circular shape when viewed from the axial direction of the liner 102. The cross-sectional shape of the first reinforcing cap 148 is a semicircular shape when viewed from a direction orthogonal to the axial direction of the liner 102. The thickness of the first reinforcing cap 148 in the radial direction is substantially constant. The first reinforcing cap 148 is disposed between the outer circumferential surface of the first dome portion 112a of the liner 102 and the first fitting concave part 150 of the first cap main body 146. The first reinforcing cap 148 covers the outer circumferential surface of the first dome portion 112a. When the gas filling chamber 20 of the liner 102 is filled with the hydrogen gas, the first reinforcing cap 148 can bear the circumferential load on the first dome portion 112a. Specifically, the first cap member 1421 has a two layer structure in which the first cap main body 146 and the first reinforcing cap 148 are stacked in the radial direction.

The second cap member 1422 includes a second cap main body 152 and a second reinforcing cap 154. The second cap main body 152 is formed of a metal material. The second cap main body 152 has a quadrangular shape when viewed from the axial direction of the liner 102. When viewed from a direction orthogonal to the axial direction of the liner 102, the second curved outer surface 1242 of the second cap main body 152 is formed in a semicircular shape in cross section. The second cap member 1422 includes a second fitting concave part 156 on the inner side thereof. The second reinforcing cap 154 is fitted into the second fitting concave part 156. The second fitting concave part 156 has a hemispherical surface.

The second reinforcing cap 154 is formed in a cup shape from a fiber reinforced resin (FRP). The second reinforcing cap 154 has a circular shape when viewed from the axial direction of the liner 102. The cross-sectional shape of the second reinforcing cap 154 is a semicircular shape when viewed from a direction orthogonal to the axial direction of the liner 102. The thickness of the second reinforcing cap 154 in the radial direction is substantially constant. The second reinforcing cap 154 is disposed between the outer circumferential surface of the second dome portion 112b of the liner 102 and the second fitting concave part 156 of the second cap member 1422. The second reinforcing cap 154 covers the outer circumferential surface of the second dome portion 112b. When the gas filling chamber 20 of the liner 102 is filled with the hydrogen gas, the second reinforcing cap 154 can bear the circumferential load on the second dome portion 112b. Specifically, the second cap member 1422 has a two layer structure in which the second cap main body 152 and the second reinforcing cap 154 are stacked in the radial direction.

A third hole portion 158 is formed at the center of each of the first and second reinforcing caps 148 and 154 so as to penetrate therethrough in the axial direction. The ferrule main body 118 of the ferrule 104 is inserted into the third hole portion 158. It should be noted that the present invention is not limited to the configuration in which the first and second dome portions 112a and 112b are each provided with the ferrule 104, and at least one of the first and second dome portions 112a and 112b may be provided with the ferrule 104.

As described above, in the third embodiment, the first and second cap members 1421 and 1422 include the first and second reinforcing caps 148 and 154 made of a fiber-reinforced resin, respectively, and when a load is applied in the direction in which the liner 102 is expanded by the pressure of the hydrogen gas in the gas filling chamber 20, the load applied to the first and second dome portions 112a and 112b can be suitably absorbed by the first and second reinforcing caps 148 and 154. Thus, by providing the first and second reinforcing caps 148 and 154, the strength of the first and second cap members 1421 and 1422 can be improved without increasing the size of the first and second cap members 1421 and 1422.

The above-described embodiments can be summarized in the following manner.

According to the above-described embodiments, provided is the high pressure tank including: the liner (12, 102) which is made of resin, and includes the cylinder portion (22) having a round tubular shape, and the gas filling chamber (20) formed in the interior of the liner; the first cap member (161, 1061, 1421) attached to one end part in the axial direction of the liner; the second cap member (162, 1062, 1422) attached to another end part in the axial direction of the liner; the reinforcing layer (14) configured to cover an outer surface of the cylinder portion and including the first reinforcing fibers (261) hoop-wound a plurality of times along a circumferential direction of the cylinder portion; and the reinforcing member (18) that is laid over the first cap member and the second cap member, and includes the second reinforcing fibers (381) hoop-wound around the first cap member and the second cap member a plurality of times, the second reinforcing fibers extending in the axial direction of the cylinder portion between the first cap member and the second cap member.

Each of the first cap member and the second cap member includes the curved outer surface (321, 322, 1222, 1242) that bulges convexly in a direction away from the central portion in the axial direction of the cylinder portion as viewed from a direction orthogonal to an axis line of the cylinder portion, and the reinforcing member is attached to the curved outer surface of the first cap member and the curved outer surface of the second cap member.

The curved outer surface is an arc-shaped outer surface.

The liner has a round tubular shape as a whole, the first cap member is the first boss member (161a) attached to one end part in the axial direction of the cylinder portion of the liner, and the second cap member is the second boss member (162a) attached to another end part in the axial direction of the cylinder portion of the liner.

The liner includes the first dome portion (112a) having a curved shape and disposed at one end part in the axial direction of the cylinder portion, and the second dome portion (112b) having a curved shape and disposed at another end part in the axial direction of the cylinder portion, the first cap member includes the first concave part (1221) lying along a shape of the first dome portion, and covers the first dome portion with the first concave part, and the second cap member includes the second concave part (1241) lying along a shape of the second dome portion, and covers the second dome portion with the second concave part.

The first cap member includes the first cap main body (146) formed of a metal material, and the first reinforcing cap (148) made of the fiber reinforced resin and disposed between the outer surface of the first dome portion and the first cap main body, the second cap member includes the second cap main body (152) formed of a metal material, and the second reinforcing cap (154) made of the fiber reinforced resin and disposed between the outer surface of the second dome portion and the second cap main body, the first reinforcing cap includes the first concave part, the second reinforcing cap includes the second concave part, the first cap main body includes the first fitting concave part (150) into which the first reinforcing cap is fitted, and the second cap main body includes the second fitting concave part (156) into which the second reinforcing cap is fitted.

The high pressure tank further includes the cushion member (82) having an elastic force and disposed between the reinforcing member and at least one of the first cap member or the second cap member.

Under the condition that the internal pressure of the gas filling chamber is 0 MPa and the ambient temperature of the high pressure tank is 23° C., an amount of compressive deformation of the cushion member corresponds to 0.2% to 0.7% of the axial length of the liner.

The curved outer surface includes the groove portion (72) extending in the winding direction of the second reinforcing fibers.

The present invention is not limited to the above disclosure, and various modifications are possible without departing from the essence and gist of the present invention.

1. A high pressure tank comprising:
a liner which is made of resin, and includes a cylinder portion having a round tubular shape, and a gas filling chamber formed in an interior of the liner;
a first cap member attached to one end part in an axial direction of the liner;
a second cap member attached to another end part in the axial direction of the liner;
a reinforcing layer configured to cover an outer surface of the cylinder portion and including first reinforcing fibers hoop-wound a plurality of times along a circumferential direction of the cylinder portion; and
a reinforcing member that is laid over the first cap member and the second cap member, and includes second reinforcing fibers hoop-wound around the first cap member and the second cap member a plurality of times, the second reinforcing fibers extending in an axial direction of the cylinder portion between the first cap member and the second cap member.

2. The high pressure tank according to claim 1, wherein
each of the first cap member and the second cap member includes a curved outer surface that bulges convexly in a direction away from a central portion in the axial direction of the cylinder portion as viewed from a direction orthogonal to an axis line of the cylinder portion, and
the reinforcing member is attached to the curved outer surface of the first cap member and the curved outer surface of the second cap member.

3. The high pressure tank according to claim 2, wherein
the curved outer surface is an arc-shaped outer surface.

4. The high pressure tank according to claim 1, wherein
the liner has a round tubular shape as a whole,
the first cap member is a first boss member attached to one end part in the axial direction of the cylinder portion of the liner, and
the second cap member is a second boss member attached to another end part in the axial direction of the cylinder portion of the liner.

5. The high pressure tank according to claim 1, wherein
the liner includes:
a first dome portion having a curved shape and disposed at one end part in the axial direction of the cylinder portion; and
a second dome portion having a curved shape and disposed at another end part in the axial direction of the cylinder portion,
the first cap member includes a first concave part lying along a shape of the first dome portion, and covers the first dome portion with the first concave part, and
the second cap member includes a second concave part lying along a shape of the second dome portion, and covers the second dome portion with the second concave part.

6. The high pressure tank according to claim 5, wherein
the first cap member includes a first cap main body formed of a metal material, and a first reinforcing cap made of a fiber reinforced resin and disposed between an outer surface of the first dome portion and the first cap main body,
the second cap member includes a second cap main body formed of a metal material, and a second reinforcing cap made of the fiber reinforced resin and disposed between an outer surface of the second dome portion and the second cap main body,
the first reinforcing cap includes the first concave part,
the second reinforcing cap includes the second concave part,
the first cap main body includes a first fitting concave part into which the first reinforcing cap is fitted, and
the second cap main body includes a second fitting concave part into which the second reinforcing cap is fitted.

7. The high pressure tank according to claim 1, further comprising a cushion member having an elastic force and disposed between the reinforcing member and at least one of the first cap member or the second cap member.

8. The high pressure tank according to claim 7, wherein
under a condition that an internal pressure of the gas filling chamber is 0 MPa and an ambient temperature of the high pressure tank is 23° C., an amount of compressive deformation of the cushion member corresponds to 0.2% to 0.7% of an axial length of the liner.

9. The high pressure tank according to claim 2, wherein
the curved outer surface includes a groove portion extending in a winding direction of the second reinforcing fibers.
